(19) United States
(12) Patent Application Publication
(10) Pub. No.: US 2021/0146693 A1
(43) Pub. Date: May 20, 2021

(54) CONNECTOR AND INKJET PRINTER

(71) Applicant: MIMAKI ENGINEERING CO., LTD., Nagano (JP)

(72) Inventor: Sotaro Kanai, Nagano (JP)

(73) Assignee: MIMAKI ENGINEERING CO., LTD., Nagano (JP)

(21) Appl. No.: 17/092,344

(22) Filed: Nov. 9, 2020

(30) Foreign Application Priority Data
Nov. 18, 2019 (JP) 2019-208047

(51) Int. Cl. B41J 2/175; B41J 2/14

(52) U.S. Cl. CPC B41J 2/17523; B41J 2202/19; B41J 2/17556; B41J 2/14

(57) ABSTRACT

A connector includes a damper, a tube connecting member, and a sealing member having elasticity for preventing leakage of ink from between the damper and the tube connecting member. The tube connecting member includes a coupling part coupled to the damper by overlapping the damper in a radial direction of the flow path for each combination in which the flow path of the damper and the flow path of the tube connecting member are connected to each other. The sealing member is disposed in contact with the coupling part. The tube connecting member includes a continuous part continuously formed across multiple coupling parts, and a tongue-shaped piece portion extending from the continuous part. The continuous part is disposed on an outermost side of the connector in the vicinity of the sealing member. The tongue-shaped piece portion includes a claw that engages with the damper on a free end side.

### CROSS REFERENCE TO RELATED APPLICATIONS

This application claims the priority benefit of Japanese Patent Application No. 2019-208047, filed on Nov. 18, 2019. The entirety of the above-mentioned patent application is hereby incorporated by reference herein and made a part of this specification.

### TECHNICAL FIELD

The present disclosure relates to a connector that connects flow paths to each other and an inkjet printer.

### DESCRIPTION OF THE BACKGROUND ART

As a conventional connector, a connector including a first member in which a flow path is formed and a second member in which a flow path connected to the flow path of the first member is formed is known (see Japanese Utility Model Publication No. 63-004376, Patent Literature 1). The second member includes a tongue-shaped piece portion having a tongue-shaped piece form provided on the free end side with an engaging portion that engages with the first member. The first member and the second member are joined by the engaging portion of the tongue-shaped piece portion of the second member engaging with the first member.

Patent Literature 1: Japanese Utility Model Publication No. 63-004376

In the conventional connector, it is conceivable to provide a sealing member having elasticity between the first member and the second member in order to prevent fluid leakage from between the first member and the second member.

However, in the conventional connector, when a sealing member having elasticity is provided between the first member and the second member, one of the first member and the second member tends to easily tilt with respect to the other member by the elasticity of the sealing member, and thus the engagement between the engaging portion of the tongue-shaped piece portion of the second member and the first member, that is, the joining between the first member and the second member tends to be accidentally released easily.

Therefore, the present disclosure provides a connector and an inkjet printer that can reduce the possibility of the joining of members being accidentally released.

### SUMMARY

A connector of the present disclosure relates to a connector including a first member in which a plurality of flow paths is provided; a second member in which a plurality of flow paths connected to the flow paths of the first member is provided; and a sealing member having elasticity, configured to prevent leakage of fluid from between the first member and the second member; where the second member includes a coupling part coupled to the first member by overlapping the first member in a radial direction of the flow path for each combination in which the flow path of the first member and the flow path of the second member are connected to each other; the sealing member is disposed in contact with the coupling part for each combination; the second member includes a continuous part continuously provided across a plurality of the coupling parts, and a tongue-shaped piece portion having a tongue-shaped piece form extending from the continuous part; the continuous part is disposed on an outermost side of the connector in a vicinity of the sealing member; and the tongue-shaped piece portion includes an engaging portion that engages with the first member on a free end side.

With this configuration, in the connector of the present disclosure, the second member includes a the coupling part coupled to the first member by overlapping the first member in the radial direction of the flow path and the continuous part disposed on the outermost side of the connector in the vicinity of the sealing member and formed continuously across a plurality of coupling parts, and the tongue-shaped piece portion including the engaging portion that engages with the first member is extended from the continuous part, so that the root of the tongue-shaped piece portion is reinforced by the continuous part, whereby one of the first member and the second member can be suppressed from being tilted with respect to the other one of the first member and the second member by the elasticity of the sealing member, and consequently, the possibility of the engagement between the engaging portion of the tongue-shaped piece portion of the second member and the first member, that is, the joining of the first member and the second member being accidentally released can be reduced.

In the connector of the present disclosure, the tongue-shaped piece portion may be disposed on a side opposite to a side of the coupling part with respect to the sealing member.

In the connector of the present disclosure, a portion of the tongue-shaped piece portion on a side of the continuous part is thicker than a portion of the tongue-shaped piece portion on the free end side.

With this configuration, in the connector of the present disclosure, since the portion of the tongue-shaped piece portion on the continuous part side is thicker than the portion of the tongue-shaped piece portion on the free end side, the amount of bend of the portion of the tongue-shaped piece portion on the continuous part side due to an external force can be reduced. Furthermore, in the connector of the present disclosure, since the portion of the tongue-shaped piece portion on the continuous part side is thicker than the portion of the tongue-shaped piece portion on the free end side, as compared with a case where the thickness of the tongue-shaped piece portion is uniformly made thick from the continuous part side to the free end side to reduce the possibility of the joining between the first member and the second member being accidentally released, the force necessary for bending the portion of the tongue-shaped piece portion on the free end side can be reduced, and as a result, the force necessary for the work of joining the first member and the second member can be reduced.

In the connector of the present disclosure, the tongue-shaped piece portion may include: a rib on the portion on the side of the continuous part, configured to make the portion of the tongue-shaped piece portion on the side of the continuous part thicker than the portion of the tongue-shaped piece portion on the free end side; and the rib may be disposed on the portion on both end sides of the tongue-shaped piece portion in a direction orthogonal to both the direction in which the tongue-shaped piece portion is extended from the continuous part and the thickness direction of the tongue-shaped piece portion.

With this configuration, in the connector of the present disclosure, since the ribs for making the portion of the tongue-shaped piece portion on the continuous part side thicker than the portion of the tongue-shaped piece portion on the free end side are disposed at portions on both end sides in the width direction of the tongue-shaped piece portion, as compared with a case where the rib is disposed at the center in the width direction of the tongue-shaped piece portion, the twist of the tongue-shaped piece portion in the rotating direction centered on a straight line extending in the direction in which the tongue-shaped piece portion is extended from the continuous part can be reduced, and as a result, the possibility of the engagement between the engaging portion of the tongue-shaped piece portion of the second member and the first member, that is, the joining between the first member and the second member being accidentally released can be reduced.

In the connector of the present disclosure, the portion of the tongue-shaped piece portion on the side of the continuous part may be longer than the portion of the tongue-shaped piece portion on the free end side with respect to a width in a direction orthogonal to both the direction in which the tongue-shaped piece portion is extended from the continuous part and the thickness direction of the tongue-shaped piece portion.

With this configuration, in the connector of the present disclosure, since the portion of the tongue-shaped piece portion on the continuous part side is longer than the portion of the tongue-shaped piece portion on the free end side, as compared with a case where the width of the tongue-shaped piece portion is the same from the continuous part side to the free end side, the force necessary for bending the portion of the tongue-shaped piece portion on the free end side can be reduced, and as a result, the force necessary for the work of joining the first member and the second member can be reduced.

The connector of the present disclosure may further include a tilt suppressing part configured to suppress the second member from tilting with respect to the first member; where the tilt suppressing part may be disposed on an outer side of the connector with respect to the tongue-shaped piece portion in a thickness direction of the tongue-shaped piece portion.

With this configuration, in the connector of the present disclosure, when the second member is tilted with respect to the first member, the tongue-shaped piece portion of the second member comes into contact with the tilt suppressing part of the first member, and thus the second member can be suppressed from tilting with respect to the first member up to an angle at which the engagement of the tongue-shaped piece portion of the second member with the first member by the engaging portion is released, and as a result, the possibility of the engagement between the engaging portion of the tongue-shaped piece portion of the second member and the first member, that is, the joining between the first member and the second member being accidentally released can be reduced.

An inkjet printer of the present disclosure includes the connector described above and an inkjet head; where the fluid is an ink; and at least one of the first member and the second member is a damper configured to adjust a pressure of the ink supplied to the inkjet head.

With this configuration, in the inkjet printer of the present disclosure, even if the pressure of the ink in the connector is changed by the damper, one of the first member and the second member can be suppressed from tilting with respect to the other member upon receiving the pressure of the ink, and as a result, the possibility of the joining between the first member and the second member being released can be reduced, and drawbacks caused by leakage of ink in the connector can be reduced.

The connector and the inkjet printer of the present disclosure can reduce the possibility of the joining of members being accidentally released.

### BRIEF DESCRIPTION OF THE DRAWINGS

FIG. 1 is a perspective view of an inkjet printer according to a first embodiment of the present disclosure.

FIG. 2 is a perspective view of a connector 20 included in the inkjet printer shown in FIG. 1.

FIG. 3 is a front view of the connector shown in FIG. 2.

FIG. 4A is a side view of the connector shown in FIG. 2.

FIG. 4B is a cross-sectional view taken along the line A-A of FIG. 3.

FIG. 5 is a block diagram of the inkjet printer shown in FIG. 1.

FIG. 6 is a front view of an example of the connector according to the first embodiment, which is different from the examples shown in FIGS. 2 to 4B.

FIG. 7 is a perspective view of an example of the connector according to the first embodiment, which is different from the examples shown in FIGS. 2 to 4B and 6.

FIG. 8 is a perspective view of an inkjet printer according to a second embodiment of the present disclosure.

FIG. 9 is a front view of the connector shown in FIG. 8.

FIG. 10A is a side view of the connector shown in FIG. 8.

FIG. 10B is a cross-sectional view taken along the line B-B of FIG. 9.

FIG. 11 is a side cross-sectional view of the vicinity of the claw of the tongue-shaped piece portion of a tube connecting member of the connector shown in FIG. 8.

FIG. 12 is a side cross-sectional view of an example of the vicinity of the claw of the tongue-shaped piece portion of the tube connecting member of the connector according to the second embodiment, which is different from the example shown in FIG. 11.

FIG. 13 is a perspective view of an example of the connector according to the second embodiment, which is different from the examples shown in FIGS. 8 to 12.

FIG. 14 is a front view of the connector shown in FIG. 13.

FIG. 15 is a side view of the connector shown in FIG. 13.

### DETAILED DESCRIPTION OF EMBODIMENTS

Hereinafter, an embodiment of the present disclosure will be described with reference to the drawings.

### First Embodiment

First, the configuration of an inkjet printer according to the present embodiment will be described.

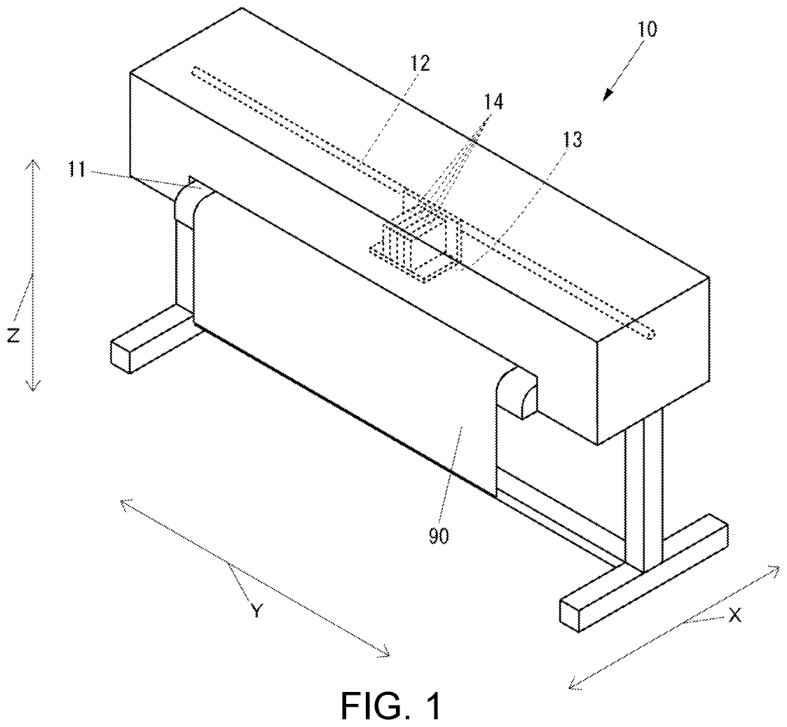

FIG. 1 is a perspective view of an inkjet printer 10 according to the present embodiment.

As shown in FIG. 1, the inkjet printer 10 includes a platen 11 that supports a recording medium 90 from below in the vertical direction indicated by arrow Z, a rail 12 that extends in the left-right direction indicated by arrow Y orthogonal to the vertical direction, a carriage 13 that is disposed on the upper side in the vertical direction with respect to the recording medium 90 supported by the platen 11 and is supported by the rail 12 so as to be movable in the left-right direction, and a plurality of inkjet heads 14 mounted on the carriage 13.

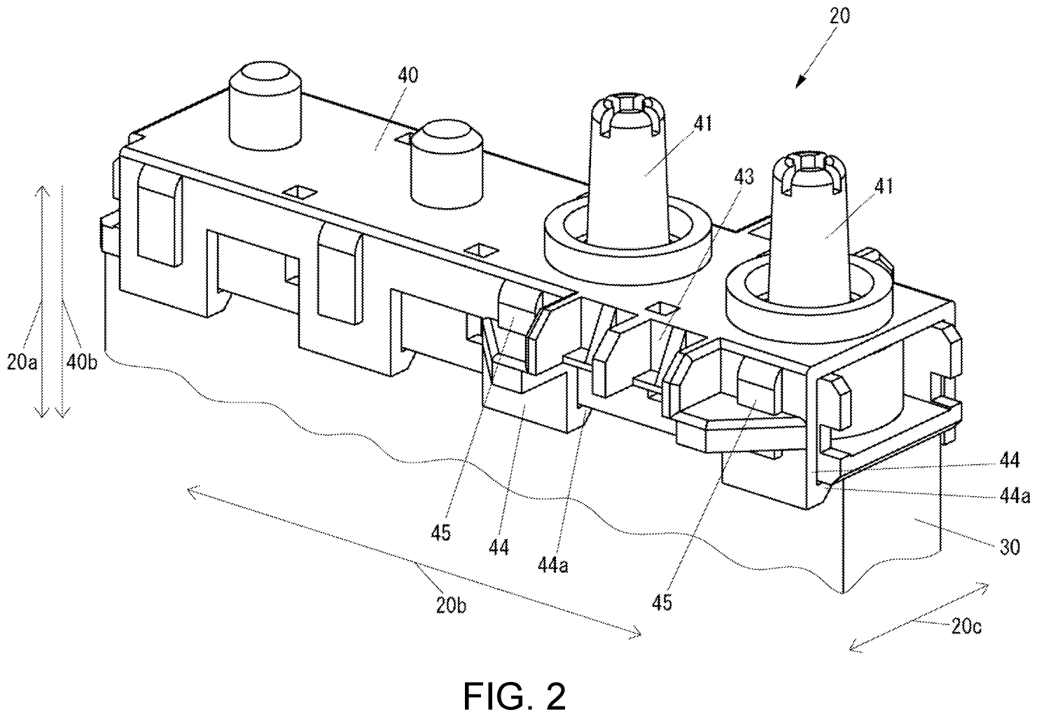

FIG. 2 is a perspective view of the connector 20 included in the inkjet printer 10.

The inkjet printer 10 (see FIG. 1) includes a damper 30 that adjusts the pressure of the ink supplied to the inkjet head 14 (see FIG. 1). The damper 30 is mounted on the carriage 13 (see FIG. 1). The damper 30 is disposed between an ink tank (not shown) and the inkjet head 14 in the ink flow path.

The damper 30 forms a part of the connector 20 for connecting the tube forming a part of the ink flow path to the damper 30.

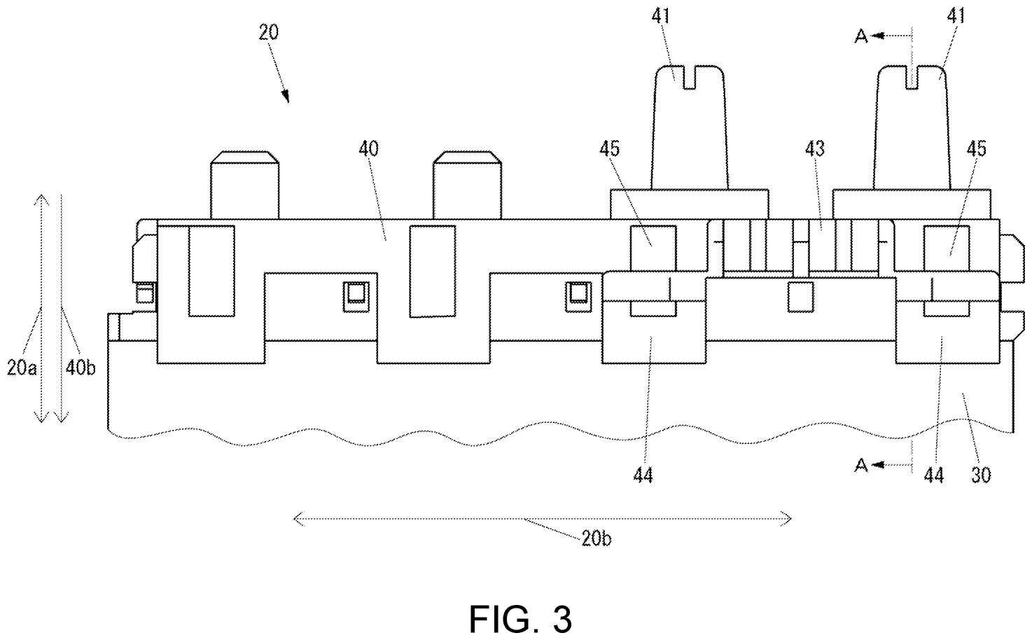

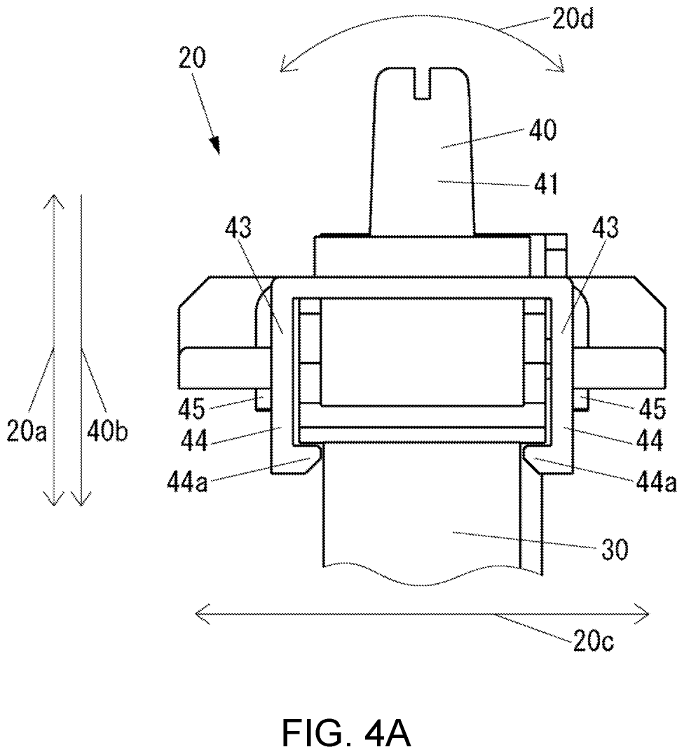

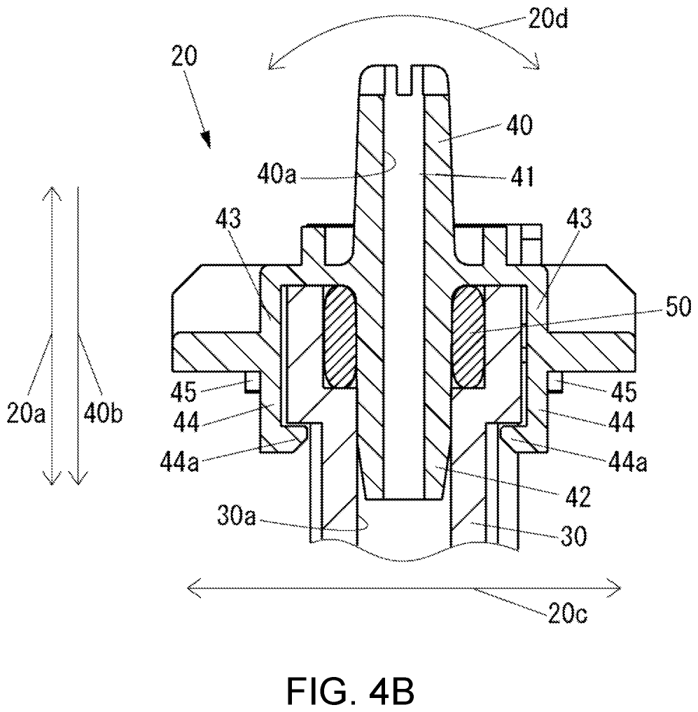

FIG. 3 is a front view of the connector 20 shown in FIG. 2. FIG. 4A is a side view of the connector 20 shown in FIG. 2. FIG. 4B is a cross-sectional view taken along the line A-A of FIG. 3.

As shown in FIGS. 2 to 4B, the connector 20 includes a damper 30 serving as a first member of the present disclosure, a tube connecting member 40 serving as a second member of the present disclosure to which a tube (not shown) is connected, and a sealing member 50 having elasticity for preventing leakage of the fluid from between the damper 30 and the tube connecting member 40.

The tube connecting member 40 includes two tube connecting parts 41 to which tubes are respectively connected.

The tube connecting member 40 has a coupling part 42 that is extended to the side opposite to the tube connecting part 41 and is coupled to the damper 30 by being inserted into the damper 30 for each of the two tube connecting parts 41. The coupling part 42 overlaps the damper 30 in the radial direction of the flow path 40a of the tube connecting member 40, which will be described later, and is coupled to the damper 30. The coupling part 42 is provided for each combination of the flow path 40a of the tube connecting member 40 and the flow path 30a of the damper 30, which will be described later. That is, the tube connecting member 40 includes the two coupling parts 42.

In the tube connecting member 40, the flow path 40a that connects the distal end of the tube connecting part 41 to the distal end of the coupling part 42 is formed for each of the two tube connecting parts 41. That is, the tube connecting member 40 is formed with two flow paths 40a. Each of the two flow paths 40a extends in the direction indicated by the arrow 20a. The two flow paths 40a are arranged side by side in the direction indicated by the arrow 20b, which is orthogonal to the direction indicated by the arrow 20a.

The tube connecting member 40 includes a continuous part 43 that is continuously formed across the two coupling parts 42. The continuous part 43 is disposed on the outermost side of the connector 20 in the vicinity of the sealing member 50 in the direction indicated by the arrow 20c which is orthogonal to both the direction indicated by the arrow 20a and the direction indicated by the arrow 20b. The continuous part 43 is disposed on both sides of the coupling part 42 in the direction indicated by the arrow 20c.

The tube connecting member 40 includes a tongue-shaped piece portion 44 having a tongue-shaped piece form extending from the continuous part 43 in a direction indicated by an arrow 40b. The tongue-shaped piece portion 44 is provided with a claw 44a serving as an engaging portion that engages with the damper 30 on the free end side opposite to the side connected to the continuous part 43.

The tube connecting member 40 includes, for each tongue-shaped piece portion 44, a rib 45 provided from the continuous part 43 to the portion of the tongue-shaped piece portion 44 on the continuous part 43 side. The rib 45 is for making a portion of the tongue-shaped piece portion 44 on the continuous part 43 side thicker than a portion of the tongue-shaped piece portion 44 on the free end side.

In the damper 30, a flow path 30a connected to the flow path 40a of the tube connecting member 40 is formed for each flow path 40a. That is, the damper 30 is formed with two flow paths 30a.

The damper 30 has a pressure chamber (not shown) for adjusting the pressure of the ink. Each of the two flow paths 30a communicates with different pressure chambers. That is, the damper 30 has two pressure chambers.

The sealing member 50 is, for example, an 0 ring. The sealing member 50 is disposed in contact with the coupling part 42 of the tube connecting member 40 for each combination of the flow path 40a of the tube connecting member 40 and the flow path 30a of the damper 30 that are connected to each other.

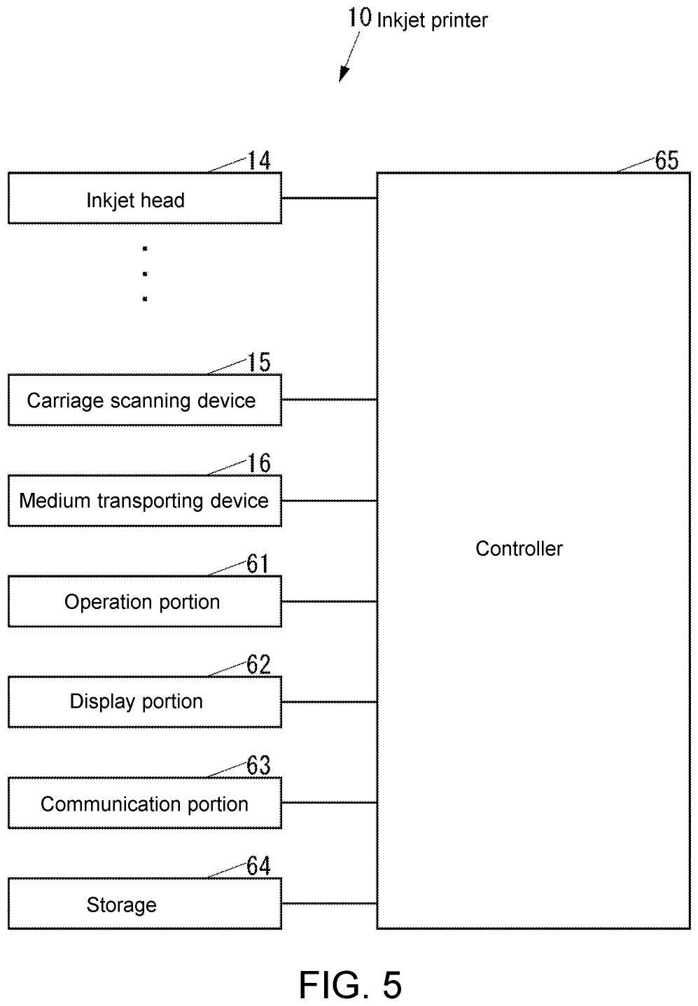

FIG. 5 is a block diagram of the inkjet printer 10.

As shown in FIG. 5, the inkjet printer 10 includes the inkjet head 14 described above, a carriage scanning device 15 that moves the carriage 13 (see FIG. 1) in the left-right direction, that is, the main scanning direction along the rail 12 (see FIG. 1), a medium transporting device 16 that transports the recording medium 90 (see FIG. 1) in a front-back direction, that is, the sub scanning direction indicated by an arrow X (see FIG. 1) orthogonal to both the vertical direction and the left-right direction, an operation portion 61 such as, for example, a button to which various operations are input, a display portion 62 such as a liquid crystal display (LCD) that displays various information, a communication portion 63 which is a communication device that communicates with an external device through a network such as local area network (LAN) or Internet or directly in a wired or wireless manner without interposing the network, a storage 64 which is a nonvolatile storage device such as a semiconductor memory or a hard disk drive (HDD), for example, that stores various types of information, and a controller 65 that controls the entire inkjet printer 10.

The controller 65 includes, for example, a central processing unit (CPU), a read only memory (ROM) that stores programs and various data in advance, and a random access memory (RAM) used as a work area of the CPU. The CPU executes the program stored in the ROM or the storage 64.

Next, the operation of the inkjet printer 10 will be described.

Upon receiving the print data through the communication portion 63, the controller 65 executes printing on the recording medium 90 based on the print data. That is, the controller 65 moves the carriage 13 in the main scanning direction by the carriage scanning device 15 and ejects the ink toward the recording medium 90 by the inkjet head 14 to execute printing on the recording medium 90 in the main scanning direction. Furthermore, when printing on the recording medium 90 in the main scanning direction is executed, the controller 65 transports the recording medium 90 in the sub scanning direction by the medium transporting device 16, as necessary, thereby changing the position of printing with respect to the recording medium 90 in the sub scanning direction, and thereafter executing printing with respect to the recording medium 90 in the main scanning direction again.

As described above, in the connector 20, the tube connecting member 40 includes the coupling part 42 coupled to the damper 30 by overlapping the damper 30 in the radial direction of the flow path 40a of the tube connecting member 40, and the continuous part 43 disposed on the outermost side of the connector 20 in the vicinity of the sealing member 50 and formed continuously across a plurality of coupling parts 42, and the tongue-shaped piece portion 44 including the claw 44a that engages with the damper 30 is extended from the continuous part 43, so that the root of the tongue-shaped piece portion 44 is reinforced by the continuous part 43, whereby one of the damper 30 and the tube connecting member 40 can be suppressed from being tilted with respect to the other one of the damper 30 and the tube connecting member 40 by the elasticity of the sealing member 50, and consequently, the possibility of the engagement between the damper 30 and the claw 44a of the tongue-shaped piece portion 44 of the tube connecting member 40, that is, the joining of the damper 30 and the tube connecting member 40 being accidentally released can be reduced.

With respect to the position in the direction indicated by the arrow 40b in which the tongue-shaped piece portion 44 is extended from the continuous part 43, the connector 20 has a distal end on the free end side of the tongue-shaped piece portion 44 existing in the direction indicated by the arrow 40b with respect to the sealing member 50. Therefore, the connector 20 can secure a sufficiently large area of the portion of the tongue-shaped piece portion 44 that comes into contact with the damper 30 in the direction indicated by the arrow 20c, and as a result, the amount of bend of the tongue-shaped piece portion 44 by the external force in the direction indicated by the arrow 20c can be reduced. Therefore, the connector 20 can reduce the possibility that the joining between the damper 30 and the tube connecting member 40 is accidentally released.

With respect to the position in the direction indicated by the arrow 40b, the connector 20 has the distal end on the free end side of the tongue-shaped piece portion 44 existing in the direction indicated by the arrow 40b with respect to the sealing member 50. Therefore, the connector 20 can suppress the rotation of the tube connecting member 40 with respect to the damper 30 in the rotating direction indicated by the arrow 20d (see FIGS. 4A and 4B) that is centered on the straight line passing through the sealing member 50 and extending in the direction indicated by the arrow 20b, that is, the rotation having the sealing member 50 as a fulcrum, and as a result, the possibility of the engagement between the damper 30 and the claw 44a of the tongue-shaped piece portion 44 of the tube connecting member 40, that is, joining between the damper 30 and the tube connecting member 40 being accidentally released can be reduced.

In the connector 20, since the portion of the tongue-shaped piece portion 44 on the continuous part 43 side is thicker than the portion of the tongue-shaped piece portion 44 on the free end side due to the presence of the rib 45, the amount of bend of the portion of the tongue-shaped piece portion 44 on the continuous part 43 side due to an external force in the direction indicated by the arrow 20c can be reduced. Furthermore, since the portion of the tongue-shaped piece portion 44 on the continuous part 43 side is thicker than the portion of the tongue-shaped piece portion 44 on the free end side due to the presence of the rib 45 in the connector 20, as compared with a case where the thickness of the tongue-shaped piece portion 44 is uniformly made thick from the continuous part 43 side to the free end side to reduce the possibility of the joining between the damper 30 and the tube connecting member 40 being accidentally released, the force necessary for bending the portion of the tongue-shaped piece portion 44 on the free end side can be reduced, and as a result, the force necessary for the work of joining the damper 30 and the tube connecting member 40 can be reduced. Moreover, the connector 20 can reduce the force required to bend the portion on the free end side of the tongue-shaped piece portion 44, and thus can also reduce the force necessary for the work of releasing the joining between the damper 30 and the tube connecting member 40.

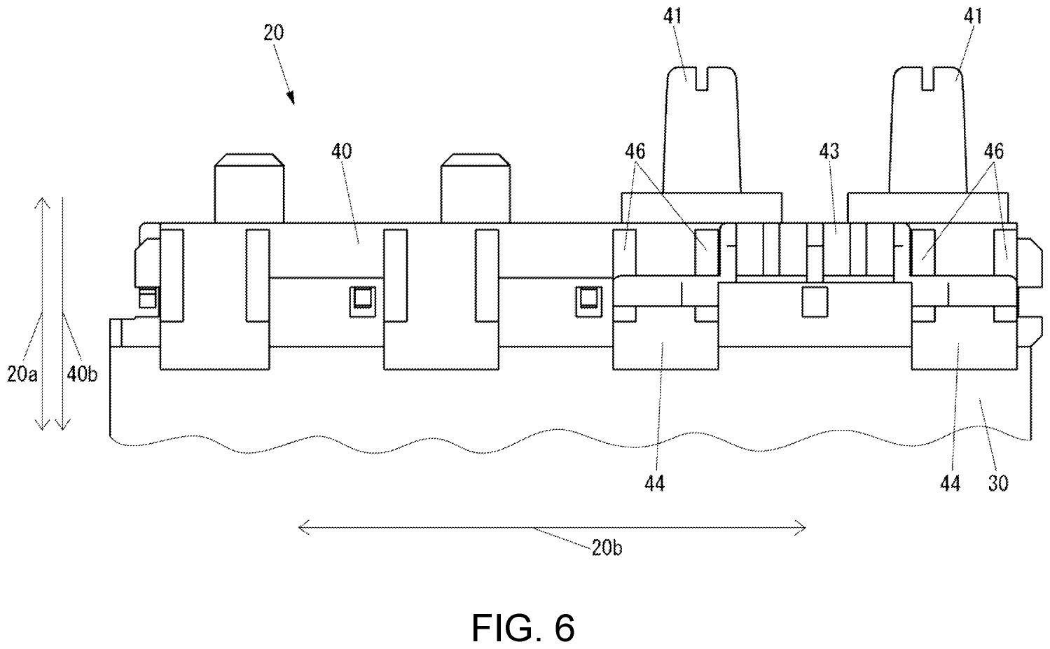

FIG. 6 is a front view of an example of the connector 20 according to the present embodiment, which is different from the examples shown in FIGS. 2 to 4B.

The configuration of the connector 20 shown in FIG. 6 is the same as the configuration in which the connector 20 shown in FIGS. 2 to 4B includes the ribs 46 respectively disposed at portions on both end sides of the tongue-shaped piece portion 44 in the direction indicated by the arrow 20b in place of the ribs 45 (see FIG. 3).

In the connector 20, since the ribs 46 for making the portion of the tongue-shaped piece portion 44 on the continuous part 43 side thicker than the portion of the tongue-shaped piece portion 44 on the free end side are disposed at portions on both end sides in the width direction of the tongue-shaped piece portion 44, as compared with a case where the rib 45 is disposed at the center in the width direction of the tongue-shaped piece portion 44 as shown in FIG. 3, the twist of the tongue-shaped piece portion 44 in the rotating direction centered on a straight line extending in the direction indicated by the arrow 40b in which the tongue-shaped piece portion 44 is extended from the continuous part 43 can be reduced, and as a result, the possibility of the engagement between the damper 30 and the claw 44a of the tongue-shaped piece portion 44 of the tube connecting member 40, that is, the joining between the damper 30 and the tube connecting member 40 being accidentally released can be reduced.

The connector 20 may not include a rib for making the portion of the tongue-shaped piece portion 44 on the continuous part 43 side thicker than the portion of the tongue-shaped piece portion 44 on the free end side.

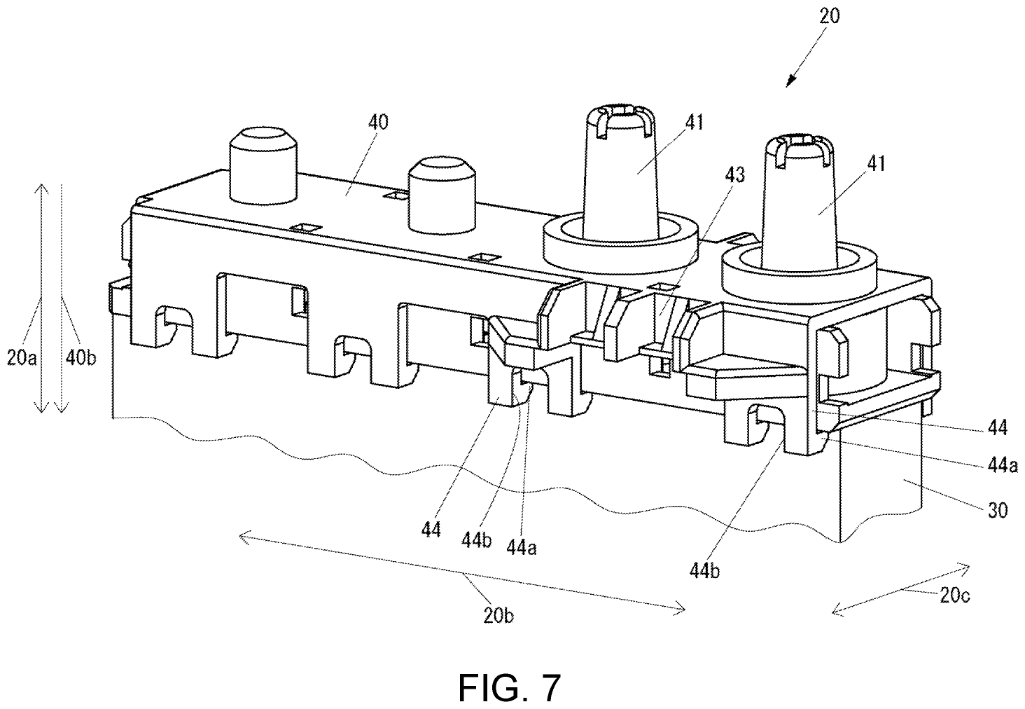

FIG. 7 is a perspective view of an example of the connector 20 according to the present embodiment, which is different from the examples shown in FIGS. 2 to 4B and 6.

The configuration of the connector 20 shown in FIG. 7 is the same as the configuration in which the connector 20 shown in FIGS. 2 to 4B has a slit 44b formed at the distal end of the tongue-shaped piece portion 44 on the free end side, and the connector 20 shown in FIGS. 2 to 4B does not have the rib 45 (see FIG. 3).

In the connector 20 shown in FIG. 7, a slit 44b is formed at the distal end of the tongue-shaped piece portion 44 on the free end side. Therefore, in the connector 20 shown in FIG. 7, the portion of the tongue-shaped piece portion 44 on the continuous part 43 side is longer than the portion of the tongue-shaped piece portion 44 on the free end side with respect to the width in the direction indicated by the arrow 20b. Therefore, as compared with a case where the width of the tongue-shaped piece portion 44 is the same from the continuous part 43 side to the free end side, the connector 20 shown in FIG. 7 can reduce the force required to bend the portion of the tongue-shaped piece portion 44 on the free end side, and as a result, can reduce the force necessary for the work of joining the damper 30 and the tube connecting member 40 and can also reduce the force necessary for the work of releasing the joining between the damper 30 and the tube connecting member 40.

The connector 20 shown in FIG. 7 may further include a rib for making the portion of the tongue-shaped piece portion 44 on the continuous part 43 side thicker than the portion of the tongue-shaped piece portion 44 on the free end side.

The inkjet printer 10 can suppress one of the damper 30 and the tube connecting member 40 from tilting with respect to the other one, even if, for example, the tube connecting member 40 is pulled by a tube connected to the tube connecting member 40, and as a result, the possibility of the joining between the damper 30 and the tube connecting member 40 being released can be reduced. Furthermore, in the inkjet printer 10, even if the pressure of the ink in the connector 20 is changed by the damper 30, one of the damper 30 and the tube connecting member 40 can be suppressed from tilting with respect to the other one upon receiving the pressure of the ink, and as a result, the possibility of the joining between the damper 30 and the tube connecting member 40 being released can be reduced. Therefore, the inkjet printer 10 can reduce drawbacks due to leakage of ink in the connector 20.

The connector 20 connects a tube to the damper 30 in the present embodiment. However, the connector 20 can be employed at various locations in the inkjet printer 10, such as the location of a degassing module for removing gas in the ink.

### Second Embodiment

First, the configuration of an inkjet printer according to the present embodiment will be described.

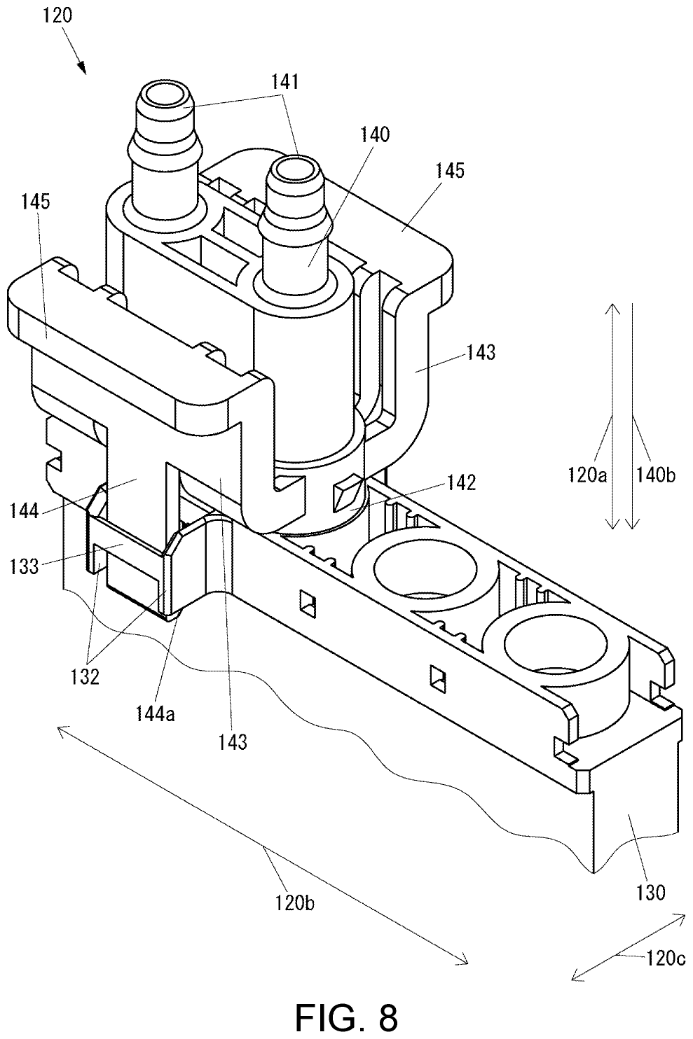

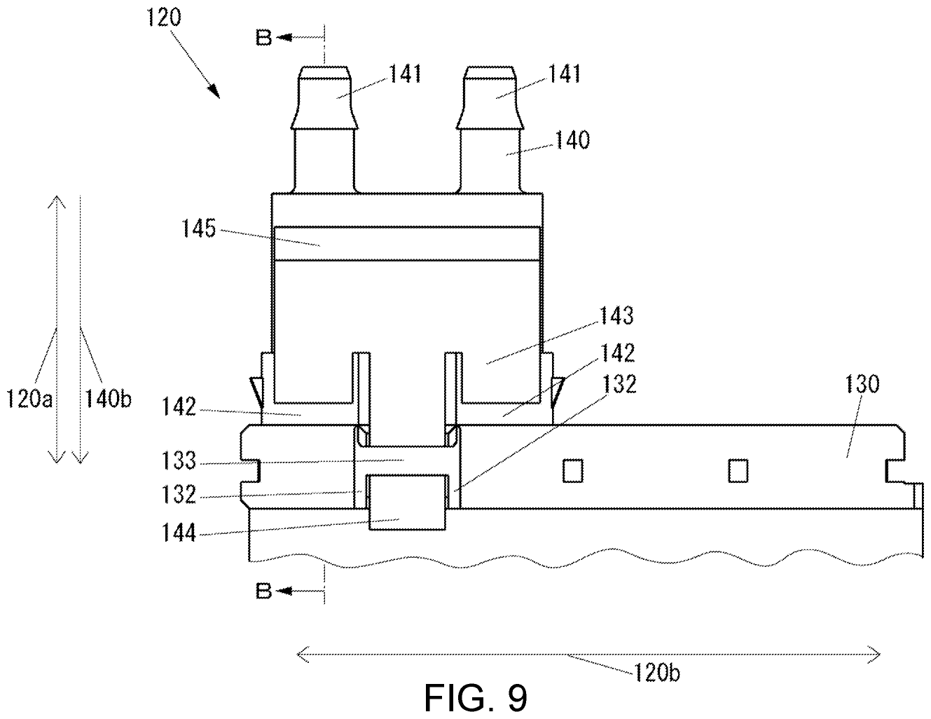

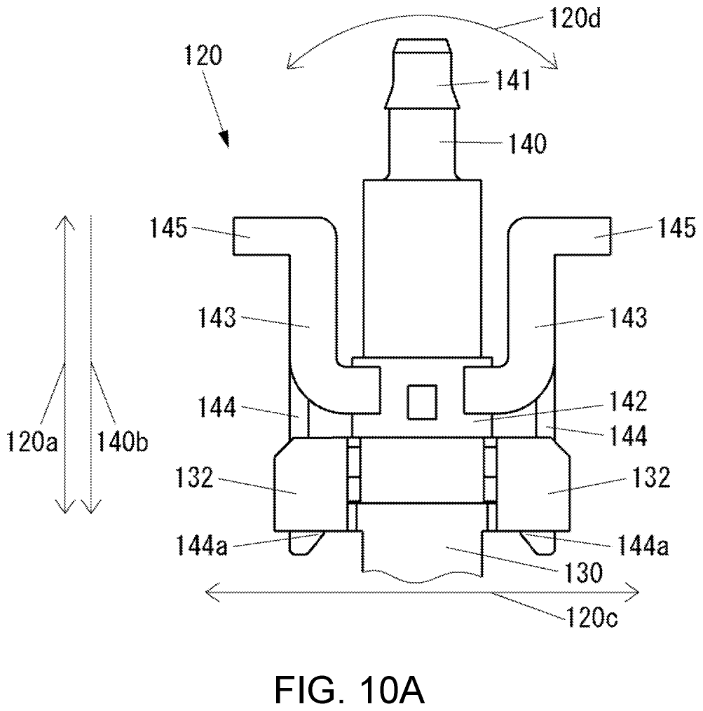

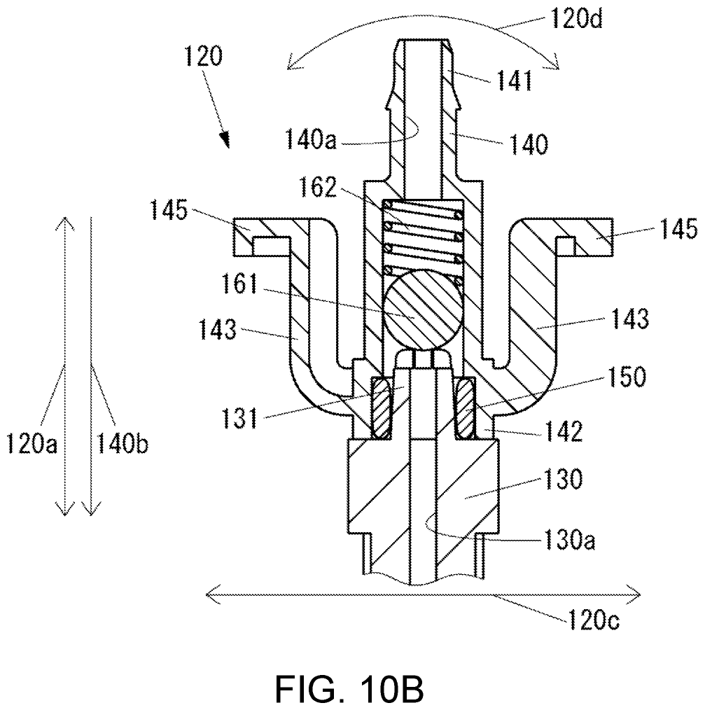

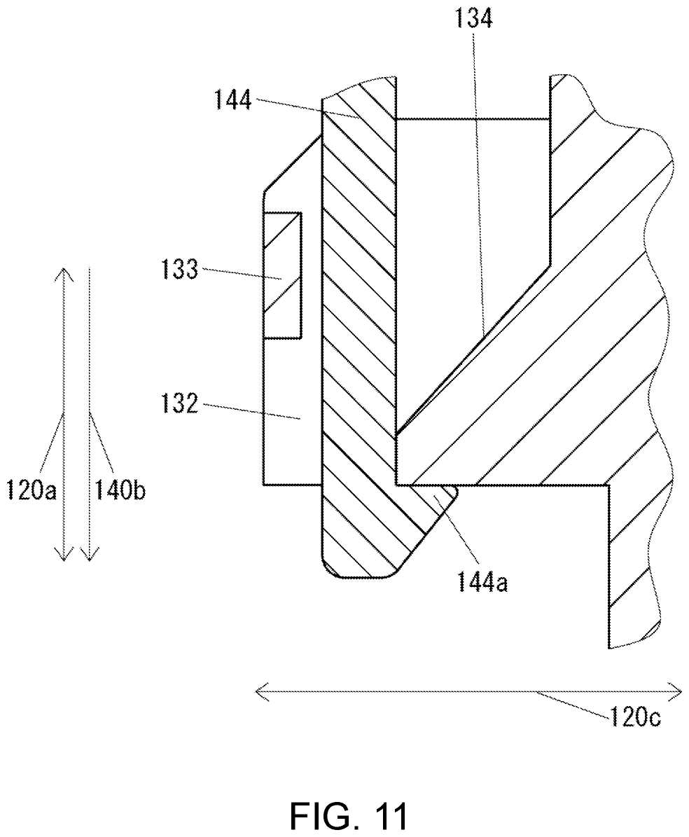

FIG. 8 is a perspective view of a connector 120 of an inkjet printer according to the present embodiment. FIG. 9 is a front view of the connector 120 shown in FIG. 8. FIG. 10A is a side view of the connector 120 shown in FIG. 8. FIG. 10B is a cross-sectional view taken along the line B-B of FIG. 9. FIG. 11 is a side cross-sectional view of the vicinity of the claw 144a of the tongue-shaped piece portion 144 of the tube connecting member 140 of the connector 120 shown in FIG. 8.

The configuration of the inkjet printer according to the present embodiment is similar to the configuration in which the inkjet printer 10 (see FIG. 1) according to the first embodiment includes the connector 120 shown in FIGS. 8 to 11 in place of the connector 20 (see FIGS. 2 to 4).

As shown in FIGS. 8 to 11, the connector 120 includes a damper 130 serving as a first member of the present disclosure, a tube connecting member 140 serving as a second member of the present disclosure to which a tube (not shown) is connected, a sealing member 150 having elasticity for preventing leakage of the fluid from between the damper 130 and the tube connecting member 140, and a ball 161 and a spring 162 that form a check valve along with the damper 130 and the tube connecting member 140.

The tube connecting member 140 includes two tube connecting parts 141 to which tubes are respectively connected.

The tube connecting member 140 has a coupling part 142 that is coupled to the damper 130 by being inserted into the damper 130 for each of the two tube connecting parts 141. The coupling part 142 overlaps the damper 130 in the radial direction of the flow path 140a of the tube connecting member 140, and is coupled to the damper 130. The coupling part 142 is provided for each combination of the flow path 140a of the tube connecting member 140 and the flow path 130a of the damper 130. That is, the tube connecting member 140 includes the two coupling parts 142.

In the tube connecting member 140, the flow path 140a that connects the distal end of the tube connecting part 141 to the front of the coupling part 142 is formed for each of the two tube connecting parts 141. That is, the tube connecting member 140 is formed with two flow paths 140a. Each of the two flow paths 140a extends in the direction indicated by the arrow 120a. The two flow paths 140a are arranged side by side in the direction indicated by the arrow 120b, which is orthogonal to the direction indicated by the arrow 120a.

The tube connecting member 140 includes a continuous part 143 that is continuously formed across the two coupling parts 142. The continuous part 143 is disposed on the outermost side of the connector 120 in the vicinity of the sealing member 150 in the direction indicated by the arrow 120c which is orthogonal to both the direction indicated by the arrow 120a and the direction indicated by the arrow 120b. The continuous part 143 is disposed on both sides of the coupling part 142 in the direction indicated by the arrow 120c.

The tube connecting member 140 includes a tongue-shaped piece portion 144 having a tongue-shaped piece form extending from the continuous part 143 in a direction indicated by an arrow 140b. The tongue-shaped piece portion 144 is provided with a claw 144a serving as an engaging portion that engages with the damper 130 on the free end side opposite to the side connected to the continuous part 143.

The tube connecting member 140 includes handle part 145 extending from the continuous part 143 to the side opposite to the tongue-shaped piece portion 144 on both sides in the direction indicated by the arrow 120c.

The damper 130 includes, for each coupling part 142, a projection 131 to be inserted into a hole of the coupling part 142 of the tube connecting member 140. That is, the damper 130 includes two projections 131.

In the damper 130, a flow path 130a connected to the flow path 140a of the tube connecting member 140 is formed for each flow path 140a. That is, the damper 130 is formed with two flow paths 130a. The distal end of the flow path 130a is formed at the distal end of the projection 131.

The damper 130 has a pressure chamber (not shown) for adjusting the pressure of the ink. Each of the two flow paths 130a communicates with different pressure chambers. That is, the damper 130 has two pressure chambers.

The damper 130 includes a tongue-shaped piece portion guiding part 132 that is disposed on both sides of the tongue-shaped piece portion 144 of the tube connecting member 140 in the direction indicated by the arrow 120b, and guides the movement of the tongue-shaped piece portion 144 of the tube connecting member 140 in the direction indicated by the arrow 120a, a tilt suppressing part 133 that is disposed on a side opposite to the flow path 130a side in the direction indicated by the arrow 120c with respect to the tongue-shaped piece portion 144, that is, the outer side of the connector 120, and suppresses the tube connecting member 140 from tilting with respect to the damper 130 in the rotating direction indicated by the arrow 120d centered on a straight line extending in the direction indicated by the arrow 120b, and an inclined part 134 to which the tongue-shaped piece portion 144 of the tube connecting member 140 comes into contact when the tube connecting member 140 is moved in the direction indicated by the arrow 140b with respect to the damper 130 in a case where the damper 130 and the tube connecting member 140 are joined.

The sealing member 150 is, for example, an 0 ring. The sealing member 150 is disposed in contact with the coupling part 142 of the tube connecting member 140 for each combination of the flow path 140a of the tube connecting member 140 and the flow path 130a of the damper 130 that are connected to each other.

The ball 161 and the spring 162 are disposed in the flow path 140a of the tube connecting member 140.

As described above, in the connector 120, the tube connecting member 140 includes the coupling part 142 coupled to the damper 130 by overlapping the damper 130 in the radial direction of the flow path 140a of the tube connecting member 140, and the continuous part 143 disposed on the outermost side of the connector 120 in the vicinity of the sealing member 150 and formed continuously across a plurality of coupling parts 142, and the tongue-shaped piece portion 144 including the claw 144a that engages with the damper 130 is extended from the continuous part 143, so that the root of the tongue-shaped piece portion 144 is reinforced by the continuous part 143, whereby one of the damper 130 and the tube connecting member 140 can be suppressed from being tilted with respect to the other one of the damper 130 and the tube connecting member 140 by the elasticity of the sealing member 150, and consequently, the possibility of the engagement between the damper 130 and the claw 144a of the tongue-shaped piece portion 144 of the tube connecting member 140, that is, the joining of the damper 130 and the tube connecting member 140 being accidentally released can be reduced.

In the connector 120, when the tube connecting member 140 is tilted with respect to the damper 130 in the rotating direction indicated by the arrow 120d, the tongue-shaped piece portion 144 of the tube connecting member 140 comes into contact with the tilt suppressing part 133 of the damper 130, so that the tube connecting member 140 can be suppressed from tilting with respect to the damper 130 up to an angle at which the engagement with the damper 130 by the claw 144a of the tongue-shaped piece portion 144 of the tube connecting member 140 is released, and as a result, the possibility of the engagement between the damper 130 and the claw 144a of the tongue-shaped piece portion 144 of the tube connecting member 140, that is, the joining between the damper 130 and the tube connecting member 140 being accidentally released can be reduced.

In the connector 120, since the tongue-shaped piece portion 144 of the tube connecting member 140 comes into contact with the tongue-shaped piece portion guiding part 132 of the damper 130 when the tongue-shaped piece portion 144 of the tube connecting member 140 is twisted in the rotating direction centered on a straight line extending in the direction indicated by the arrow 140b, the twist of the tongue-shaped piece portion 144 in the rotating direction centered on a straight line extending in the direction indicated by the arrow 140b can be reduced, and as a result, the possibility of the engagement between the damper 130 and the claw 144a of the tongue-shaped piece portion 144 of the tube connecting member 140, that is, the joining between the damper 130 and the tube connecting member 140 being accidentally released can be reduced.

In the connector 120, in a case where the damper 130 and the tube connecting member 140 are joined to each other, when the damper 130 and the tube connecting member 140 start to come into contact with each other, the tongue-shaped piece portion 144 of the tube connecting member 140 comes into contact with the tongue-shaped piece portion guiding part 132 of the damper 130, so that the position in the direction indicated by the arrow 120b of the tongue-shaped piece portion 144 of the tube connecting member 140 can be guided by the tongue-shaped piece portion guiding part 132 of the damper 130, and as a result, the workability in joining the damper 130 and the tube connecting member 140 can be improved.

In the connector 120, in a case where the damper 130 and the tube connecting member 140 are joined to each other, when the tube connecting member 140 is moved in the direction indicated by the arrow 140b with respect to the damper 130, the tongue-shaped piece portion 144 of the tube connecting member 140 gradually bends while contacting the inclined part 134 of the damper 130, so that the force required for the work of joining the damper 130 and the tube connecting member 140 can be reduced.

Note that the worker can release the joining between the damper 130 and the tube connecting member 140 by moving the tube connecting member 140 in the direction opposite to the direction indicated by the arrow 140b with respect to the damper 130 in a state where the engagement with the damper 130 by the claw 144a of the tongue-shaped piece portion 144 is released by the bending of the tongue-shaped piece portion 144 of the tube connecting member 140.

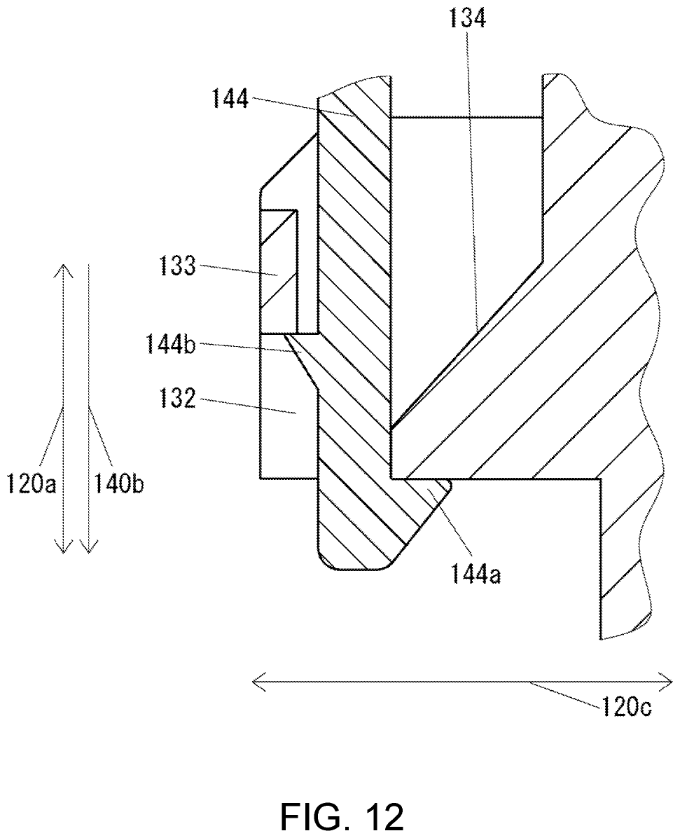

FIG. 12 is a side cross-sectional view of an example of the vicinity of the claw 144a of the tongue-shaped piece portion 144 of the tube connecting member 140 of the connector 120 according to the present embodiment, which is different from the examples shown in FIGS. 8 to 11.

The configuration of the connector 120 shown in FIG. 12 is similar to the configuration in which the connector 120 shown in FIG. 11 includes a claw 144b serving as an engaging portion that engages with the tilt suppressing part 133 of the damper 130. The possibility of the joining between the damper 130 and the tube connecting member 140 being accidentally released can be further reduced by providing the claw that engages the damper 130 in the tongue-shaped piece portion 144 on both sides in the direction indicated by the arrow 120c.

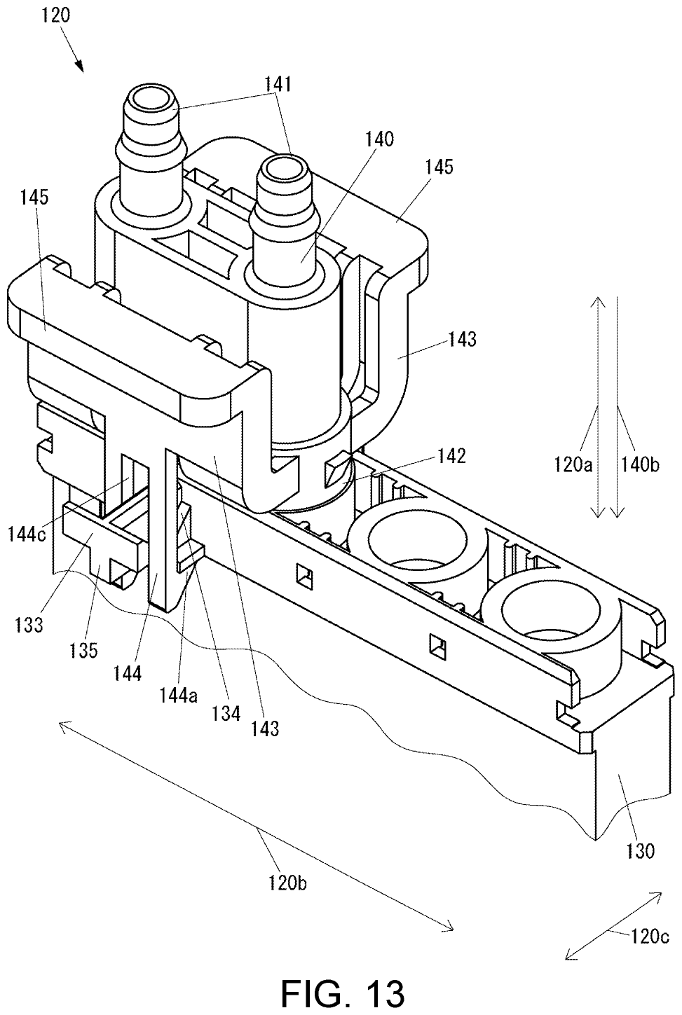

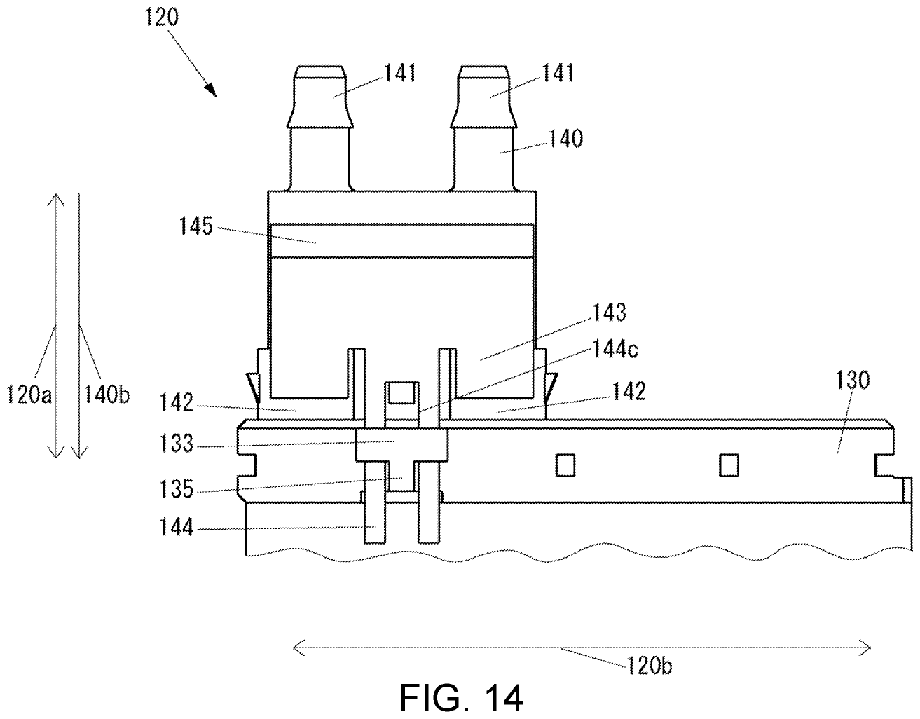

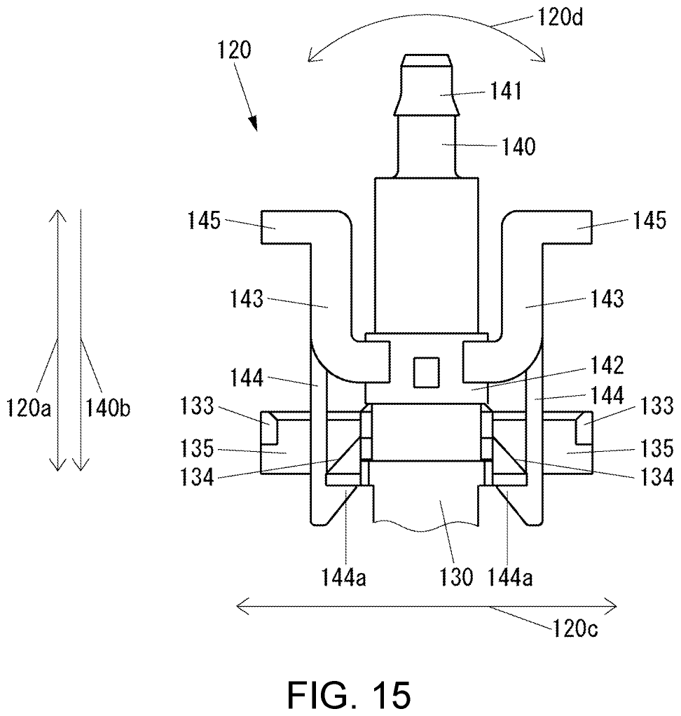

FIG. 13 is a perspective view of an example of the connector 120 according to the present embodiment, which is different from the examples shown in FIGS. 8 to 12. FIG. 14 is a front view of the connector 120 shown in FIG. 13. FIG. 15 is a side view of the connector 120 shown in FIG. 13.

The configuration of the connector 120 shown in FIGS. 13 to 15 is similar to a configuration in which the connector 120 shown in FIGS. 8 to 11 has a slit 144c formed at the distal end on the free end side of the tongue-shaped piece portion 144, and the connector 120 shown in FIGS. 8 to 11 includes a tongue-shaped piece portion guiding part 135 that guides the movement of the tongue-shaped piece portion 144 of the tube connecting member 140 in the direction indicated by the arrow 120a in place of the tongue-shaped piece portion guiding part 132 (see FIGS. 8 to 11).

In each of the embodiments described above, the inkjet printer moves the recording medium 90 in the sub scanning direction with respect to the inkjet head 14 by transporting the recording medium 90 in the sub scanning direction with respect to the platen 11. However, the inkjet printer 10 may move the inkjet head 14 in the sub scanning direction with respect to the recording medium 90 by including a mechanism that extends the platen 11 in the sub scanning direction from that shown in FIG. 1 to obtain a so-called flat bed type inkjet printer, and moves the rail 12 and the carriage 13 in the sub scanning direction with respect to the platen 11.

The present disclosure is adopted in the inkjet printer that prints on a plane in each of the above-described embodiments, but may be adopted in an inkjet printer for 3D shaping.

The connector of the present disclosure is adopted in the inkjet printer in each of the above-described embodiments. However, the connector of the present disclosure can be adopted in places other than the inkjet printer.

What is claimed is:

1. A connector, comprising:
a first member in which a plurality of flow paths is provided;
a second member in which a plurality of flow paths connected to the flow paths of the first member is provided; and
a sealing member having elasticity, configured to prevent leakage of fluid from between the first member and the second member;
wherein the second member includes a coupling part, coupled to the first member by overlapping the first member in a radial direction of the flow path for each combination in which the flow path of the first member and the flow path of the second member are connected to each other;
the sealing member is disposed in contact with the coupling part for each combination;
the second member includes:
a continuous part, continuously provided across a plurality of the coupling parts, and
a tongue-shaped piece portion, having a tongue-shaped piece form extending from the continuous part;
the continuous part is disposed on an outermost side of the connector in a vicinity of the sealing member; and
the tongue-shaped piece portion includes an engaging portion that engages with the first member on a free end side.

2. The connector according to claim 1, wherein
the tongue-shaped piece portion is disposed on a side opposite to a side of the coupling part with respect to the sealing member.

3. The connector according to claim 1, wherein
a portion of the tongue-shaped piece portion on a side of the continuous part is thicker than a portion of the tongue-shaped piece portion on the free end side.

4. The connector according to claim 3, wherein
the tongue-shaped piece portion includes: a rib on the portion on the side of the continuous part, configured to make the portion of the tongue-shaped piece portion on the side of the continuous part thicker than the portion of the tongue-shaped piece portion on the free end side; and
the rib is disposed on the portion on both end sides of the tongue-shaped piece portion in a direction orthogonal to both the direction in which the tongue-shaped piece portion is extended from the continuous part and the thickness direction of the tongue-shaped piece portion.

5. The connector according to claim 2, wherein
a portion of the tongue-shaped piece portion on a side of the continuous part is thicker than a portion of the tongue-shaped piece portion on the free end side.

6. The connector according to claim 5, wherein
the tongue-shaped piece portion includes: a rib on the portion on the side of the continuous part, configured to make the portion of the tongue-shaped piece portion on the side of the continuous part thicker than the portion of the tongue-shaped piece portion on the free end side; and
the rib is disposed on the portion on both end sides of the tongue-shaped piece portion in a direction orthogonal to both the direction in which the tongue-shaped piece portion is extended from the continuous part and the thickness direction of the tongue-shaped piece portion.

7. The connector according to claim 1, wherein
the portion of the tongue-shaped piece portion on the side of the continuous part is longer than the portion of the tongue-shaped piece portion on the free end side with respect to a width in a direction orthogonal to both the direction in which the tongue-shaped piece portion is extended from the continuous part and the thickness direction of the tongue-shaped piece portion.

8. The connector according to claim 2, wherein
the portion of the tongue-shaped piece portion on the side of the continuous part is longer than the portion of the tongue-shaped piece portion on the free end side with respect to a width in a direction orthogonal to both the direction in which the tongue-shaped piece portion is extended from the continuous part and the thickness direction of the tongue-shaped piece portion.

9. The connector according to claim 3, wherein
the portion of the tongue-shaped piece portion on the side of the continuous part is longer than the portion of the tongue-shaped piece portion on the free end side with respect to a width in a direction orthogonal to both the direction in which the tongue-shaped piece portion is extended from the continuous part and the thickness direction of the tongue-shaped piece portion.

10. The connector according to claim 4, wherein
the portion of the tongue-shaped piece portion on the side of the continuous part is longer than the portion of the tongue-shaped piece portion on the free end side with respect to a width in a direction orthogonal to both the direction in which the tongue-shaped piece portion is extended from the continuous part and the thickness direction of the tongue-shaped piece portion.

11. The connector according to claim 5, wherein
the portion of the tongue-shaped piece portion on the side of the continuous part is longer than the portion of the tongue-shaped piece portion on the free end side with respect to a width in a direction orthogonal to both the direction in which the tongue-shaped piece portion is extended from the continuous part and the thickness direction of the tongue-shaped piece portion.

12. The connector according to claim 6, wherein
the portion of the tongue-shaped piece portion on the side of the continuous part is longer than the portion of the tongue-shaped piece portion on the free end side with respect to a width in a direction orthogonal to both the direction in which the tongue-shaped piece portion is extended from the continuous part and the thickness direction of the tongue-shaped piece portion.

13. The connector according to claim 1, further comprising:
a tilt suppressing part, configured to suppress the second member from tilting with respect to the first member;
wherein the tilt suppressing part is disposed on an outer side of the connector with respect to the tongue-shaped piece portion in a thickness direction of the tongue-shaped piece portion.

14. An inkjet printer, comprising:
the connector, described in claim 1; and
an inkjet head;
wherein the fluid is an ink; and
at least one of the first member and the second member is a damper, configured to adjust a pressure of the ink supplied to the inkjet head.
